(19) United States
(12) Patent Application Publication
(10) Pub. No.: US 2015/0082085 A1
(43) Pub. Date: Mar. 19, 2015

(54) MULTI-TRANSACTIONAL SYSTEM USING TRANSACTIONAL MEMORY LOGS

(71) Applicant: Brocade Communications Systems, Inc., San Jose, CA (US)

(72) Inventors: Bill Ying Chin, San Jose, CA (US); Poongovan Ponnavaikko, Santa Clara, CA (US); Babu Neelam, Santa Clara, CA (US)

(21) Appl. No.: 14/329,720

(22) Filed: Jul. 11, 2014

Related U.S. Application Data
(60) Provisional application No. 61/845,934, filed on Jul. 12, 2013.
(60) Provisional application No. 61/864,371, filed on Aug. 9, 2013.

(51) Int. Cl. G06F 11/14; G06F 9/46

(52) U.S. Cl. CPC G06F 11/1471; G06F 11/141; G06F 9/467; G06F 2201/84
USPC 714/15

(57) ABSTRACT

Techniques are disclosed for generating a multi-transactional system using transactional memory techniques. According to certain embodiments, a device may include a memory, one or more processing entities, and a transactional memory system for maintaining a plurality of transactional memory (TM) logs in a first portion of the memory. Each TM log may be associated with one transaction from a plurality of transactions sequentially executed by the one or more processing entities and each transaction comprises a plurality of operations. Furthermore, each TM log associated with each transaction comprises information associated with changes to a second portion of the memory caused by execution of operations from the transaction using the one or more processing entities. The TM logs for completed transactions may be used for error detection and recovery and maintaining high availability of the device.

### CROSS-REFERENCES TO RELATED APPLICATIONS

The present application is a non-provisional of and claims the benefit and priority under 35 U.S.C. 119(e) of (1) U.S. Provisional Application No. 61/845,934, filed Jul. 12, 2013, entitled TRANSACTIONAL MEMORY LAYER, and (2) U.S. Provisional Application No. 61/864,371, filed Aug. 9, 2013, entitled TRANSACTIONAL MANAGEMENT LAYER. The entire contents of the 61/845,934 and 61/864,371 applications are incorporated herein by reference for all purposes.

### BACKGROUND

The disclosed embodiments relate generally to networking and more particularly to techniques for providing reliable networking functionality and high availability.

In order to reduce down-time and provide high availability, several devices, such as network devices, provide error detection and redundant processing. For error detection and recovery, a system may log the state of the current execution environment, at the time of the error or failure. In some instances, a system engineer may manually analyze the failure and perform a number procedural steps to find the root cause of the failure and bring the system back on-line. This process may result in significant down time for a device. In instances where the device may be a network device, such down-time of the device may result in network outages for extended periods of time and is undesirable for many businesses and mission critical environments.

Besides error detection, the network device may also provide redundant processing to minimize down-time in the event that the primary processing components fail or stop execution. In a device with redundant processors, at any point in time, one of the processors may be configured to operate in active mode while the other processor may operate in standby mode where the active processor is configured to perform certain functions that are not performed by the standby processor. The processor operating in the active mode is sometimes referred to as the active processor and the processor operating in standby mode is referred to as the standby processor. Processors operating according to the active/standby mode model provide redundancy such that, when the active processor fails, the standby processor becomes the active processor and starts performing the functions performed in active mode. Various events may cause a switchover (also sometimes referred to as a failover) in the network device, wherein the standby processor starts operating in the active mode and takes over routing functionality, from the previous active processor. The previously active processor may become the standby processor, as a result of the switchover.

When a switchover occurs, the new active processor rebuilds its processing and routing state information. This rebuilding or restoring of the processing and/or routing state can take several seconds or even minutes, until the new active processor has rebuilt the processing and routing state information, during which routing of traffic may be interrupted.

### BRIEF SUMMARY

Certain embodiments of the present invention provide techniques for providing reliable networking functionality and high availability using transactional memory.

Supporting high availability may be desirable for networking equipment vendors. High availability refers to a system design that ensures a high level of reliance and low down-time associated with the system. In some embodiments, high availability is facilitated by providing error detection and recovery. In many instances, error detection and recovery can result in significant downtime of the device. For instance, the error condition may be logged for later processing and the device or the process or the application running on the device may be restarted, resulting in extended periods of downtime. Restarting the process or application may result in rebuilding of state (e.g., processing and routing state) and result in additional delay before the device can come back on line and start processing network requests again.

In some embodiments, high availability is facilitated by providing redundant processing entities (e.g., two or more processors, two or more cores, etc.) with active components and standby components. However, even with redundancy, switching over from the active components to the standby components may require time for rebuilding and reinitializing the processing and routing state of the new active components.

Embodiments of the invention generally describe techniques for generating a multi-transactional system using transactional memory techniques. In certain embodiments, one or more transactional memory (TM) logs are maintained in memory for completed transactions. A transaction may comprise a plurality of operations. Each TM log is associated with a transaction and has information regarding the changes to a portion of memory caused by the operations of the transaction.

In certain embodiments, the TM logs for the completed transactions may be used for error detection and recovery. For example, if a failure is detected, the processing entity can rewind or revert the state of memory back several transactions, such that the transaction had never executed. In certain embodiments, the processing entity or other components of the device may take several remedial steps to either remedy the failure condition, work around the failure condition or retry the transactions automatically, significantly reducing the downtime for the device.

In certain embodiments, the TM logs for the completed transactions may be used in an active/standby system, where the TM logs for the completed transactions are sent by the active processing entity to the standby processing entity. The standby processing entity updates its memory state to the state of the active processing entity represented by the TM log. Since the standby processing entity synchronizes the state of its memory to the active processing entity, in the event of a switchover, the standby processing entity switches to the active processing entity and continues executing close to where the last processing left off execution.

In certain embodiments, an example device may include a memory, one or more processing entities, and a transactional memory system configurable to maintain a plurality of transactional memory (TM) logs in a first portion of the memory. Each TM log may be associated with one transaction from a plurality of transactions sequentially executed by the one or more processing entities and each transaction may include a plurality of operations. Furthermore, each TM log associated with each transaction may include information associated with changes to a second portion of the memory caused by execution of operations from the transaction using the one or more processing entities.

In some implementations of the device, the at least one of the plurality of TM logs for a completed transaction may be used for causing the state of the second portion of memory to be in a state prior to the execution of a completed transaction. In some aspects, the plurality of TM logs may be generated sequentially by the sequential execution of the plurality transactions by the one or more processing entities. In some instances, execution of a memory operation that is a write operation from a transaction from the plurality of transactions may change a second portion of memory and the TM log stored in the first portion of memory. In some aspects of the example device, each TM log associated with a completed transaction from the plurality of transactions may identify the changes to the second portion of the memory from a state prior to start of the first operation of the transaction to completion of the last operation of the completed transaction.

In certain embodiments of the example device, the transactional memory system may be further configurable to detect a failure during the execution of a current transaction by the one or more processing entities, determine that an event leading to the failure occurred during execution of operations from a completed transaction from the plurality of transactions and restore the state of the second portion of memory to a state prior to the execution of the operations from the completed transaction from the plurality of transactions using an at least one TM log.

In certain other embodiments of the example device, the transactional memory system may be further configurable to detect a failure during execution of a current transaction by the one or more processing entities, restore state of the second portion of memory to a state prior to the execution of the current transaction using a current TM log, and further incrementally restore the state of the second portion of memory to a state prior to the execution of one or more completed transactions using one or more TM logs, such that the state in the second portion of the memory that is associated with the failure is removed from the second portion of memory.

In certain embodiments, the example device comprises a first processing entity configurable to operate in a first mode, wherein the plurality of operations from the plurality of transactions are executed in the first mode by the first processing entity, and send at least one TM log for a completed transaction from the plurality of transactions to a second processing entity. The example device may also include the second processing entity configurable to operate in a second mode when the first processing entity is operating in the first mode, the second processing entity configurable to not execute the plurality of operations from the plurality of transactions in the second mode, receive the at least one TM log from the first processing entity, and update a third portion of memory maintained by the second processing entity using the TM log received from the first processing entity.

In certain embodiments, the second processing entity of the device may be further configurable to receive a signal, operate in the first mode instead of the second mode, in response to receiving the signal, and commence execution of operations starting with a first operation after the completed transaction associated with the received TM log from the first processing entity. In some instances, the first processing entity stops executing the transaction in the first mode in response to detecting a signal during execution of a transaction from the plurality of transactions.

In certain embodiments, an example method may include maintaining a plurality of transactional memory (TM) logs in a first portion of the memory. Each TM log is associated with a transaction from a plurality of transactions, wherein each transaction comprises a plurality of operations and each TM log associated with the transaction may include information associated with changes to a second portion of the memory caused by the execution of the operations of the transaction, using one or more processing entities.

In some implementations of the method, the at least one of the plurality of TM logs for a completed transaction may be used for causing the state of the second portion of memory to be in a state prior to the execution of a completed transaction. In some aspects, the plurality of TM logs may be generated sequentially by the sequential execution of the plurality transactions by the one or more processing entities. In some instances, execution of a memory operation that is a write operation from a transaction from the plurality of transactions may change a second portion of memory and the TM log stored in the first portion of memory. In some aspects of the example method, each TM log associated with a completed transaction from the plurality of transactions may identify the changes to the second portion of the memory from a state prior to the start of the first operation of the transaction to completion of the last operation of the completed transaction.

In certain embodiments of the example method, the transactional memory system may be further configurable to detect a failure during the execution of a current transaction by the one or more processing entities, determine that an event leading to the failure occurred during execution of operations from a completed transaction from the plurality of transactions and restore the state of the second portion of memory to a state prior to the execution of the operations from the completed transaction from the plurality of transactions using an at least one TM log.

In certain other embodiments of the example method, the transactional memory system may be further configurable to detect a failure during execution of a current transaction by the one or more processing entities, restore the state of the second portion of memory to a state prior to the execution of the current transaction using a current TM log, and further incrementally restore the state of the second portion of memory to a state prior to the execution of one or more completed transactions using one or more TM logs, such that the state in the second portion of the memory that is associated with the failure is removed from the second portion of memory.

In certain embodiments, the example method comprises a first processing entity configurable to operate in a first mode, wherein the plurality of operations from the plurality of transactions are executed in the first mode by the first processing entity, and send at least one TM log for a completed transaction from the plurality of transactions to a second processing entity. The example method may also include the second processing entity configurable to operate in a second mode when the first processing entity is operating in the first mode, the second processing entity configurable to not execute the plurality of operations from the plurality of transactions in the second mode, receive the at least one TM log from the first processing entity, and update a third portion of memory maintained by the second processing entity using the TM log received from the first processing entity.

In certain embodiments, the second processing entity of the method may be further configurable to receive a signal, operate in the first mode instead of the second mode, in response to receiving the signal, and commence execution of operations starting with a first operation after the completed transaction associated with the received TM log from the first processing entity. In some instance, the first processing entity stops executing the transaction in the first mode in response to detecting a signal during execution of a transaction from the plurality of transactions.

The foregoing has outlined rather broadly features and technical advantages of examples in order that the detailed description that follows can be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

FIG. 1 illustrates a simplified block diagram of a computing device executing a simplified computer program according to one or more embodiments of the invention.

FIG. 2 illustrates a simplified block diagram for writing to memory allocated as transactional memory according to one embodiment of the invention.

FIG. 3 illustrates a simplified block diagram of the computing device executing a first transaction, according to one or more embodiments of the invention.

FIG. 4 illustrates a simplified block diagram of the computing device executing a second transaction, according to one or more embodiments of the invention.

FIG. 5 illustrates a simplified block diagram of the computing device executing a yet another transaction, according to one or more embodiments of the invention.

FIG. 6 illustrates a simplified block diagram of the computing device reverting the state of a transaction in memory using a transactional memory (TM) log, according to one or more embodiments of the invention.

FIG. 7 illustrates a simplified block diagram of the computing device reverting the state of another transaction in memory using another TM log, according to one or more embodiments of the invention.

FIG. 8 illustrates a simplified block diagram of the computing device reverting the state of yet another transaction in memory using yet another TM log, according to one or more embodiments of the invention.

FIG. 9 depicts a simplified flowchart illustrating the method for maintaining TM logs, according to one or more embodiments of the invention.

FIG. 10 depicts a simplified flowchart illustrating the method performed according to one or more embodiments of the invention.

FIG. 11 illustrates another simplified block diagram of a computing device according to one or more embodiments of the invention.

FIG. 12 illustrates a simplified block diagram of the computing device for updating the memory state of a redundant processing entity using TM logs, according to one or more embodiments of the invention.

FIG. 13 depicts a simplified flowchart illustrating the method performed according to one or more embodiments of the invention.

FIG. 14 illustrates another simplified block diagram of a computing device according to one or more embodiments of the invention.

FIG. 15 depicts a simplified block diagram of a network device that may be configured to perform embodiments of the present invention.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

Embodiments of the invention generally describe techniques for generating a multi-transactional system using transactional memory techniques. In certain embodiments, the transactional memory system ensures the consistency of data stored in the transactional memory at a transaction level, where the transaction may comprise one or more operations. The transactional memory system guarantees that changes to the transactional memory caused by write and/or update operations are kept consistent at the level or atomicity of a transaction. The transactional memory system treats a transaction as a unit of work; either a transaction completes or does not. The execution of a transaction is considered to be completed if all the sequential operations defined for that transaction are completed. The execution of a transaction is considered not to be completed, i.e., considered to be incomplete, if all the sequential operations defined for that transaction are not completed. In terms of software code, a transaction represents a block of code and the transactional memory system ensures that this block of code is executed atomically. The transactional memory system ensures that changes to memory resulting from execution of the operations in a transaction are committed to the transactional memory only upon completion of the transaction. If a transaction starts execution but does not complete, i.e., all the operations in the transaction do not complete, the transactional memory system ensures that any memory changes made by the operations of the incomplete transaction are not committed to the transactional memory. Accordingly, the transactional memory system ensures that an incomplete transaction does not have any impact on the data stored in the transactional memory. The transactional memory system thus ensures the consistency of the data stored in the transactional memory at the boundary or granularity of a transaction.

A transactional memory system may use different techniques to ensure that any memory changes caused by operations of a transaction are committed to the transactional memory only upon completion of the transaction, or alternatively, to ensure that any memory changes caused by operations of an incomplete transaction are not committed to the transactional memory. In one implementation, transactional memory (TM) logs, also referred to as change logs, may be used for tracking changes to memory caused by memory operations of a transaction. In certain implementations, multiple change logs, each change log associated with a transaction, may be stored in memory to create a multi-transactional system, as discussed in further detail below.

In certain embodiments, one or more transactional memory (TM) logs are maintained in memory for completed transactions. A transaction may comprise a plurality of operations. Each TM log is associated with a transaction and has information regarding the changes to a portion of memory caused by the operations of the transaction.

In certain embodiments, the TM logs for the completed transactions may be used for error detection and recovery. For example, if a failure is detected, the processing entity can rewind or revert the state of memory back several transactions, such that the transaction had never executed. In certain embodiments, the processing entity or other components of the device may take several remedial steps to either remedy the failure condition, work around the failure condition or retry the transactions automatically, significantly reducing the downtime for the device.

In certain embodiments, the TM logs for the completed transactions may be used in an active/standby system, where the TM logs for the completed transactions are sent by the active processing entity to the standby processing entity. The standby processing entity updates its memory state to the state of the active processing entity represented by the TM log. Since the standby processing entity synchronizes the state of its memory to the active processing entity, in the event of a switchover, the standby processing entity switches to the active processing entity and continues executing close to where the last processing left off execution.

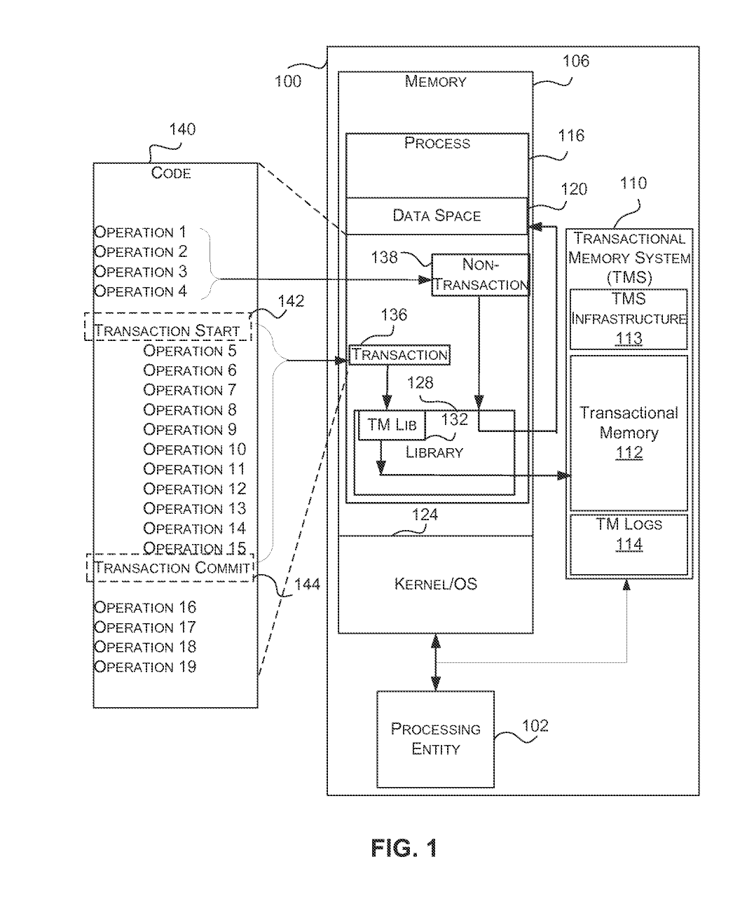

FIG. 1 illustrates a simplified block diagram of a computing device according to one or more embodiments of the invention. An example of a computing device may include a network device. Examples of network devices include devices such as routers or switches that are configured to route or forward data (e.g., packets) in a network. Examples of such network devices include various devices provided by Brocade Communications Systems, Inc. of San Jose, Calif. The computing device 100 depicted in FIG. 1, including its various components, is meant for illustrative purposes only and is not intended to limit the scope of the invention in any manner. Alternative embodiments may have more or fewer components than those shown in FIG. 1.

For illustration purposes, FIG. 1 shows one processing entity 102; however, computing device 100 may include multiple processing entities. A processing entity may be a processor, a group of physical processors, a core of a multicore processor, a group of cores of one or more multicore processors, and combinations thereof.

For example, in one embodiment, a processing entity of computing device 100 may be a physical processor, such as an Intel, AMD, or TI processor, or an ASIC. In another embodiment, a processing entity may be a group of processors. In another embodiment, a processing entity may be a processor core of a multicore processor. In yet another embodiment, a processing entity may be a group of cores from one or more processors. A processing entity can be any combination of a processor, a group of processors, a core of a processor, or a group of cores of one or more processors.

In certain embodiments, the processing entity may be a virtual processing unit or a software partitioning unit such as a virtual machine, hypervisor, software process or an application running on a processing unit, such as a physical processing unit, core or logical processor. For example, the one or more processing entities may be virtual machines executing or scheduled for execution on one or more physical processing units, one or more cores executing within the same physical processing unit or different physical processing units, or one or more logical processors executing on one or more cores on the same physical processing unit or separate physical processing units.

In certain implementations, each processing entity may have a dedicated portion of memory assigned to or associated with the processing entity. In one embodiment, the memory assigned to a processing entity is random access memory (RAM). Non-volatile memory may also be assigned in other embodiments. For example, in the embodiment depicted in FIG. 1, the processing entity 102 is coupled to memory 106.

Software instructions (e.g., software code or program) that are executed by a processing entity may be loaded into the memory 106 coupled to the processing entity 102. This software may be, for example, loaded into the memory upon initiation or boot-up of the processing entity. In one embodiment, as depicted in FIG. 1, the loaded software may include an operating environment (OS) and/or kernel 124, along with various drivers, computer applications, and other software modules. In one embodiment, if computing device 100 is a network device, a network operating system (NOS) also may be loaded into the memory after the operating system has been loaded.

As depicted in FIG. 1, memory 106 is associated with the processing entity 102. One or more applications may be loaded into memory 106 by the processing entity 102. An application may comprise one or more processes that are executed by the processing entities. In some embodiments, a process may be an instantiation of an application or computer program.

For example, as shown in FIG. 1, a process 116 may be loaded into a portion of memory 106 and executed by processing entity 102. The process may have its own memory space (data space) for storing and manipulating data (e.g., data space 120) during execution of the process. In certain implementations, a process may have multiple threads/streams of operations for executing operations concurrently.

In certain embodiments, as depicted in FIG. 1, transactional memory system 110 comprises a transactional memory 112 and an infrastructure 113 that guarantees consistency of data stored in transactional memory 112 at the atomicity of a transaction.

Memory 106, and transactional memory 112, may be physically configured in a variety of ways without departing from the scope of the invention. For example, memory 106 and transactional memory 110 may reside on one or more memory banks connected to the processing entities using shared or dedicated busses in computing device 100.

As shown in FIG. 1, transactional memory system 110 also comprises an infrastructure 113 that guarantees consistency of data stored in transactional memory 112 at the atomicity of a transaction. In conjunction with transactional memory 112, the infrastructure 113 guarantees that changes to transactional memory 112 caused by write and/or update operations are kept consistent at the level or atomicity of a transaction. Transactional memory system 110 ensures that changes to memory 112 resulting from execution of the operations in a transaction are committed to transactional memory 112 only upon completion of the transaction. If a transaction starts execution but does not complete, i.e., all the operations in the transaction do not complete, transactional memory system 110 ensures that any memory changes made by the operations of the incomplete transaction are not committed to transactional memory 212. Accordingly, transactional memory system 110 ensures that an incomplete transaction does not have any impact on the data stored in transactional memory 112. Transactional memory system 110 thus ensures the consistency of the data stored in transactional memory 112 at the boundary or granularity of a transaction. For example, in one embodiment, if a transaction executed by a processing entity encounters an event during the execution of the transaction that causes execution of the transaction to stop execution without completing all of the operations for the transaction, transactional memory system 110 may cause any memory changes resulting from the execution of the operations of the incomplete transaction to be rolled back as if those operations were never executed.

Transactional memory system 110 may be implemented using several software or hardware components, or combinations thereof. In one embodiment, the infrastructure 113 may be implemented in software, for example, using the software transactional memory support provided by GNU C Compiler (GCC) (e.g., libitm runtime library provided by GCC 4.7). Infrastructure 113 may also be implemented in hardware using transactional memory features provided by a processor. Transactional memory system 110 may also be provided using a hybrid (combination of software and hardware) approach.

In certain embodiments, a process executed by a processing entity may make use of transactional memory system 110 by linking to and loading a runtime library 132 (e.g., the libitm library provided by GCC 128) that provides various application programming interfaces (APIs) that make use of transactional memory system 110. Operations that belong to a transaction may make use of the APIs provided by such a library such that any memory operations performed by these operations use transactional memory system 110 instead of non-transactional memory. Operations that do not want to use transactional memory system 100 may use APIs provided by non-transactional libraries such that any memory operations performed using these non-transactional memory APIs use data space 120 instead of transactional memory system 210. For example, as shown in FIG. 1, a transactional operation 136 may use APIs provided by a transactional memory library (TM lib) 132 that causes transactional memory system 110 to be used for any memory operations; and a non-transactional operation 138 may use non-transactional memory libraries/APIs. For example, in one implementation, operations in a transaction that use transactional memory system 110 may be routed through TM lib 132, which provides the interface to interact with the transactional memory system 110. TM lib 132 may provide APIs for allocation of transactional memory 112, reading and writing to transactional memory 112, and the like. In this manner, all memory-related operations in a transaction are routed via TM lib 132 to transactional memory system 110.

In certain implementations, transactional memory system 110 uses TM logs 114 to guarantee consistency of data stored in transactional memory 112 on a per transaction basis. In one embodiment, for a sequence of operations in a transaction, information tracking changes to transactional memory 112, due to execution of the operations of the transaction, is stored in TM logs 114. In some instance, the TM log 114 may also be referred as the change log. The information stored is such that it enables transactional memory system 110 to reverse the memory changes if the transaction cannot be completed. In this manner, the information stored in TM logs 114 is used by transactional memory system 110 to reverse or unwind any memory changes made due to execution of operations of an incomplete transaction.

For example, for a transaction that comprises an operation that writes data to a memory location in transactional memory 112, information may be stored in a TM log 114 related to the operation and the memory change caused by the operation. For example, the information logged to a TM log 114 by transactional memory system 110 may include information identifying the particular operation, the data written by the operation or the changes to the data at the memory location resulting from the particular operation, the memory location in transactional memory 112 where the data was written, and the like. If, for some reason, the transaction could not be completed, transactional memory system 110 then uses the information stored in TM log 114 for the transaction to reverse the changes made by the write operation and restore the state of transactional memory 112 to a state prior to the execution of any operation in the transaction as if the transaction was never executed. For an incomplete transaction, the TM log information is thus used to rewind or unwind the transactional memory changes made by any executed operations of an incomplete transaction. The memory changes made by operations of an incomplete transaction are not committed to transactional memory 112. The memory changes are finalized or committed to memory only after the transaction is completed. TM logs 114 themselves may be stored in transactional memory 112 or in some other memory in or accessible to transactional memory system 110.

As depicted in FIG. 1, process 116 loaded into memory 106 and executed by processing entity 102 may contain code 140 comprising a plurality of sequential operations (e.g., code instructions). One or more blocks of code (e.g., a set of sequential operations) of code 140 may be tagged as transactions. In the example depicted in FIG. 1, the set of operations from operation_{—}5 to operation_{—}15 are tagged as belonging to single transaction 136 whereas the other operations are not tagged as belonging to any transaction. The transaction is demarcated using “transaction start” (142) and “transaction commit” (144) delimiters. In one embodiment, the “transaction start” and “transaction commit” delimiters indicate to transactional memory system 110 that the operations 5-15 are considered part of the same transaction 136, whereas the operations outside the “transaction start” and “transaction commit” demarcations are considered non-transactional operations 138.

The operations that make up a transaction are generally preconfigured. In one embodiment, a system programmer may indicate what operations or portions of code constitute a transaction. A piece of code may comprise one or more different transactions. The number of operations in one transaction may be different from the number of operations in another transaction. For example, a programmer may define a set of related sequential operations that impact memory as a transaction.

When code 140 is executed due to execution of process 116 by processing entity 102, operations that are part of a transaction, such as operations 5-15, use the transactional memory APIs provided by TM lib 132 and, as a result, transactional memory 112 is used for the memory operations. Operations that are not part of a transaction, such as operations 1-4 and 16-19, use a non-transactional memory library and, as a result, any memory operations resulting from these operations are made to data space 120 within the memory portion allocated for process 116 in memory 106.

For a transaction, the block of code corresponding to operations in the transaction is treated as an atomic unit. In one embodiment, the “transaction start” indicator (or some other indicator) indicates the start of a transaction to first processing entity 102 and the “transaction commit” indicator (or some other indicator) indicates the end of the transaction. The operations in a transaction are executed in a sequential manner by processing entity 102. As each transaction operation is executed, if the operation results in changes to be made to transactional memory 112 (e.g., a write or update operation to transactional memory 112), then, in one embodiment, the information is logged to a TM log 114. In this manner, as each operation in a transaction is executed, any memory changes caused by the execution operation are logged to TM log 114. If all the operations in the transaction (i.e., operations 5-15 for the transaction shown in FIG. 1) are successfully completed, then the changes made to transactional memory 112 are made permanent or committed to transactional memory 112. However, if the transaction could not successfully complete, then any transactional memory 112 changes made by executed operations of the incomplete transaction are reversed using information stored in TM logs 114. In this manner, the changes made by an incomplete transaction are not committed to transactional memory 112.

For example, while executing code 140, the processing entity 102 may receive an event that causes code execution by processing entity 102 to be interrupted. If the interruption occurs when the transaction comprising operations 5-15 is being executed, then any transactional memory 112 changes made by the already executed operations of the incomplete transaction are reversed, using information stored in TM logs 114. For example, if the interruption occurs when operation_{—}9 has been executed and operation_{—}10 is about to be executed, any changes to transactional memory 112 caused by execution of operations 5-9 are reversed and not committed to transactional memory 112. In this manner, transactional memory system 110 ensures that the state of data stored in transactional memory 112 is as if the incomplete transaction was never executed.

In certain embodiments, the transactional memory 112 and the TM log 114 may be implemented using memory that is persistent across a failover. During the reboot, the power planes associated with the processing entities and the memory may also be rebooted. Rebooting of the power planes may result in losing of the data stored in memory. In certain embodiments, to avoid losing data stored in the transactional memory 112 and the TM logs 114, the library may allocate the memory using persistent memory. In one implementation, persistent memory may be implemented using non-volatile memory, such as flash memory, that retains data even when not powered. In another implementation, persistent memory may be implemented by keeping the memory powered during the period when the computing device 100 reboots. In some implementations, the transactional memory 112 and the TM logs 114 may be implemented on a separate power plane so that they do not lose power and consequently data while other entities in the network device lose power and reboot.

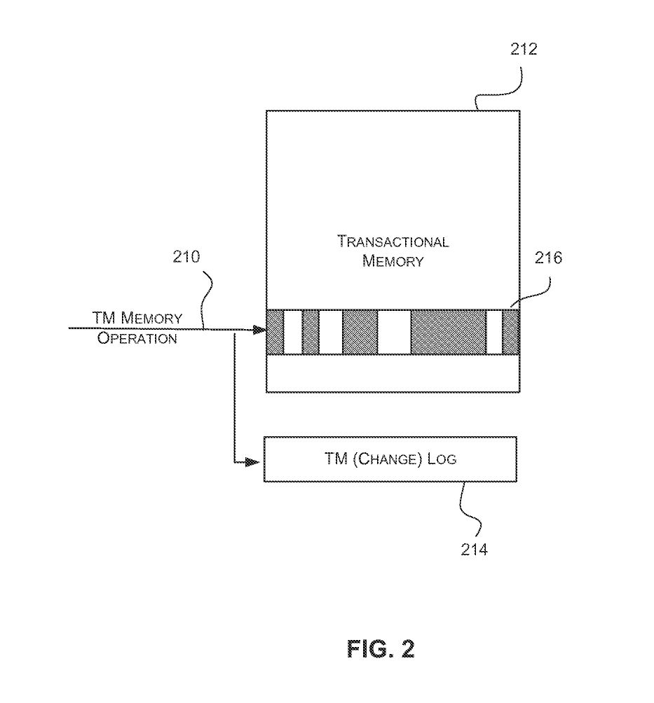

FIG. 2 illustrates a simplified block diagram for writing to transactional memory allocated as part of the transactional memory system according to certain embodiments of the invention. In FIG. 2, execution of TM memory operations 136 may result in changes to the transactional memory 212, maintained as part of the transactional memory system, and may be stored to the transactional memory 212 itself. Along with storing the change to transactional memory 212, the changes or representations of the changes are also stored in the TM logs 214. The TM logs 214 may also be referred to as change logs. In certain embodiments, the transactional memory system uses TM logs 214 to guarantee consistency of data stored in transactional memory 216 on a per transaction basis. In one embodiment, for a sequence of operations in a transaction, information tracking changes to a portion of the transactional memory 216 due to execution of the operations of the transaction is stored in the TM log 214. The information stored is such that it enables the transactional memory system to reverse the memory changes if the transaction cannot be completed. In this manner, the information stored in TM logs 214 is used by the transactional memory system to reverse or unwind any memory changes made due to execution of operations of an incomplete transaction.

For example, for a transaction that comprises an operation that writes data to a memory location in transactional memory 216, information may be stored in a TM log 114 related to the operation and the memory change caused by the operation. For example, the information logged to a TM log 214 by the transactional memory system may include information identifying the particular operation, the data written by the operation or the changes to the data at the memory location resulting from the particular operation, the memory location in transactional memory where the data was written, and the like. If, for some reason, the transaction could not be completed, transactional memory system 110 then uses the information stored in TM log 114 for the transaction to reverse the changes made by the write operation and restore the state of the portion of the transactional memory 216 to a state prior to the execution of any operation in the transaction as if the transaction was never executed. For an incomplete transaction, the TM log information is thus used to rewind or unwind the transactional memory changes made by any executed operations of an incomplete transaction. The memory changes made by operations of an incomplete transaction are not committed to memory 212. The memory changes are finalized or committed to memory only after the transaction is completed. TM logs 214 themselves may be stored in transactional memory 212 or in some other memory in or accessible to transactional memory system.

As described earlier, the changes to the portion of the transactional memory 216 are committed to transactional memory 212 at the transaction boundary. For example, in FIG. 1, the changes are committed upon execution of the “transaction commit” 144. In FIG. 2, if the transaction stops without completing the transaction, the changes to the transactional memory 112 may be rolled back, using information stored in the TM logs 214.

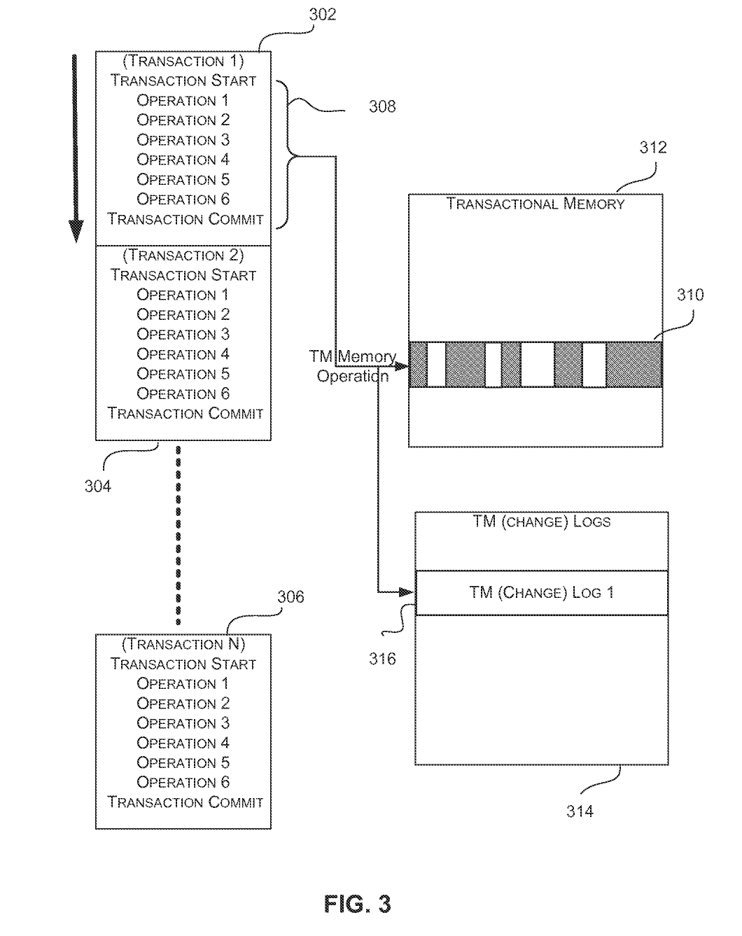

FIG. 3 illustrates a simplified block diagram for storing TM logs for multiple transactions, according to aspects of the disclosure. FIG. 3 depicts a stream of code including multiple subsequent transactions.

As depicted in FIG. 3, a process loaded into memory and executed by a processing entity may contain code comprising a plurality of sequential transactions, each transaction comprising a plurality of operations (e.g., code instructions). In the example depicted in FIG. 3, multiple transactions (i.e., transaction 1 (302), transaction 2 (304), . . . , transaction N (306)) are demarcated using “transaction start” and “transaction commit” delimiters for each transaction. In one embodiment, the “transaction start” and “transaction commit” delimiters indicate to transactional memory system 110 that the operations are considered part of the same transaction.

The operations that make up a transaction are generally preconfigured. In one embodiment, a system programmer may indicate what operations or portions of code constitute a transaction. A piece of code may comprise one or more different transactions. The number of operations in one transaction may be different from the number of operations in another transaction. For example, a programmer may define a set of sequential operations related that impact memory as a transaction.

FIG. 3 depicts the execution of transaction 1 (302) and the changes stored in the transactional memory 312 and TM log 316. When the transaction 302 is executed due to execution of the process by a processing entity, operations that are part of a transaction use the transactional memory APIs provided by TM lib 132 and, as a result, transactional memory 312 is used for the memory operations.

For a transaction, the block of code corresponding to operations in the transaction is treated as an atomic unit. In one embodiment, the “transaction start” indicator (or some other indicator) indicates the start of a transaction to processing entity 102 and the “transaction commit” indicator (or some other indicator) indicates the end of the transaction. The operations in a transaction are executed in a sequential manner by the processing entity 102. As each transaction operation is executed, if the operations are memory operations (308) and result in changes to be made to portion 310 of the transactional memory 312 (e.g., a write or update operation to transactional memory 312), then, in one embodiment, the information is logged to a TM log 316. In this manner, as each operation in a transaction is executed, any memory changes caused by the execution of the operation are logged to TM log 316. If all the operations in the transaction are successfully completed, then the changes made to transactional memory 310 are made permanent or committed to transactional memory 312.

FIG. 3 depicts the execution and completion of operations in transaction 1 (302). Once the transaction 1 (302) is completed, all the changes to the portion 310 of transactional memory 312 caused by the execution of the operations from the transaction 1 (302) may be reflected in the TM log 1 (316). In other words, the TM log 1 (316) may represent all the changes to the state of the portion 310 of the transaction memory 312 from prior to the execution of the first instruction of the transaction 1 (302) to the completion of all the operations from transaction 1 (302). Using the changes stored in the TM log 1 (314) associated with the transaction 1 (302), it may be possible to revert or rewind the portion of transactional memory 310 from the state that represents the completion of transaction 1 (302) back to a state prior to the execution of the first operation of transaction 1 (302). In certain embodiments of the invention, the TM log 1 (314) is retained in memory.

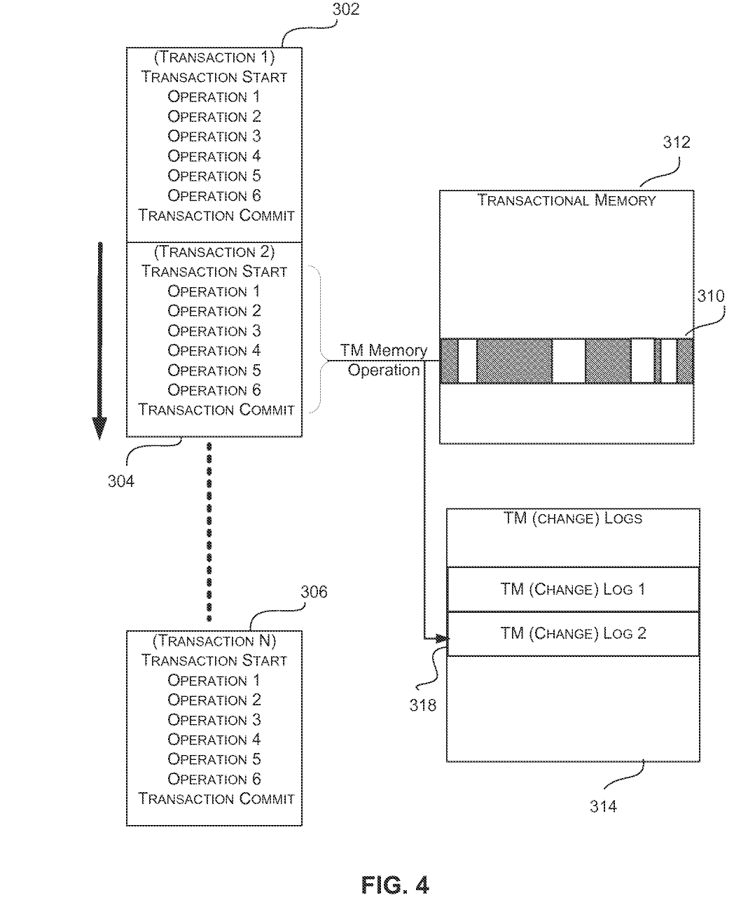

Similar to FIG. 3, FIG. 4 depicts the execution and completion of operations from transaction 2 (304). Once the execution of operations from transaction 2 (304) are completed, all the changes to the portion 310 of transactional memory 312 caused by the execution of the operations from the transaction 2 (304) may be reflected in the TM log 2 (318). Collectively. TM log 1 (314) and TM log 2 (316) may represent all the changes to the state of the portion 310 of transactional memory 312 caused by the execution of the operations from transaction 1 (302) and transaction 2 (304).

In certain embodiments of the invention, multiple TM logs, such as TM log 1 (302) and TM log 2 (304) may be stored in memory. The number of TM logs stored in memory may be based on a retention policy for the TM logs. The retention policy may be static or dynamic. For example, the retention policy may be pre-configured and based on a configuration parameter set by the user, manufacturer or programmer. In certain embodiments of the invention, the retention policy may be based on the amount of system memory, an expiration timer for a TM log, successful completion of a task or any other event or system state without departing from the scope of the invention. For example, in one implementation, the system may be configured to store N number of TM logs for a process.

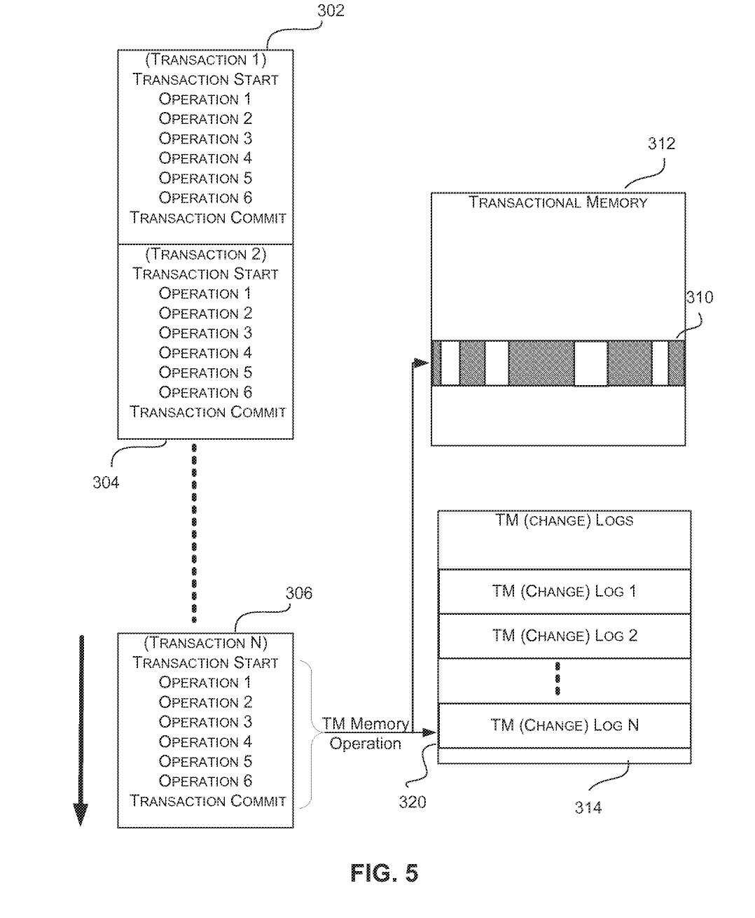

FIG. 5 depicts the execution and completion of operations from transaction N (306). Information associated with the changes to the portion 310 of transactional memory 312 caused by the operations from transaction N (306) are stored in TM log N (320) reserved for the TM logs 314. In certain embodiments, the information stored in the TM log N (320) may be used in reversing the changes caused by the execution of the operations from the transaction N (306).

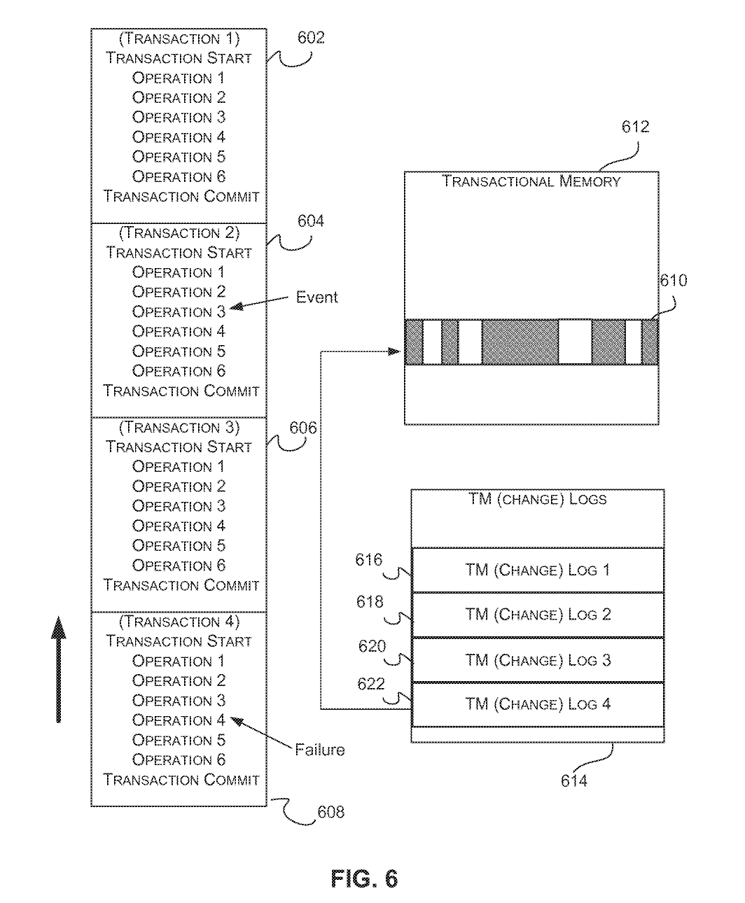

FIG. 6 also depicts multiple transactions executing sequentially, similar to what has been described with respect to FIG. 3, FIG. 4 and FIG. 5. In FIG. 6, operations from transaction 1 (602), transaction 2 (604) and transaction 3 (606) complete and respectively update TM log 1 (616), TM log 2 (618), and TM log 3 (620). As previously described, each of TM logs comprises information reflecting the changes to the state of the portion 610 of the transactional memory 612 caused by the respective transactions. In certain embodiments, collectively TM log 1 (616), TM log 2 (618), and TM log 3 (620) represent the changes to the portion 610 of transactional memory 612 caused by the execution of operations from transaction 1 (602), transaction 2 (604) and transaction 3 (606), such that the TM logs may be used, individually or collectively, in reverting the state of the portion 610 of transactional memory 612 to the state prior to the execution of any of the executed transactions, allowing for a multi-transactional system.

However, if a transaction could not successfully complete, then any changes to the portion 610 of the transactional memory 612 made by executed operations of the incomplete transaction (i.e., transaction 4 (608)) are reversed using information stored in a TM log (i.e., TM log 4 (622)). In this manner, the changes made by an incomplete transaction are not committed to transactional memory.

FIG. 6 further depicts execution of the operations from transaction 4 (608). As the operations from transaction 4 (608) execute and make changes to the portion of transactional memory 610, the TM log 4 (622) is also incrementally updated with information reflecting the changes to the portion of transactional memory 610. As shown in FIG. 6, while executing transaction 4 (608), the processing entity 102 may detect a failure at operation_{—}4 of the transaction that causes code execution by processing entity 102 to be interrupted. Any changes to the portion of the transactional memory 610 made by the already executed operations of the incomplete transaction are reversed, using information stored in TM log 4 (622). For example, using information stored in the TM log 4 (622), any changes to the portion of transactional memory 610 caused by execution of operations 1-3 of transaction 4 (608) are reversed and not committed to transactional memory 112. In this manner, transactional memory system 110 ensures that the state of data stored in transactional memory 612 is as if none of the operations that form the incomplete transaction were ever executed.

In certain embodiments, the transactional memory 612 and the TM logs 614 may be implemented using memory that is persistent across a failover. During the reboot, the power planes associated with the processing entities and the memory may also be rebooted. Rebooting of the power planes may result in losing of the data stored in memory. In certain embodiments, to avoid losing data stored in the transactional memory 612 and the TM logs 614, the library may allocate the memory using persistent memory. In one implementation, persistent memory may be implemented using non-volatile memory, such as flash memory, that retains data even when not powered. In another implementation, persistent memory may be implemented by keeping the memory powered during the period when the computing device reboots. In some implementations, the transactional memory 612 and the TM logs 614 may be implemented on a separate power plane so that they do not lose power and consequently data while other entities in the network device, lose power and reboot.

In some instances, a failure event may be detected by a checking operation operating as part of the transaction. In other instances, the failure event may cause the execution to be handled by a fault handler. In yet other instances, the failure event may cause a failure of the process or the processing entity and result in a reboot of the process or the processing entity. In certain embodiments, in response to a failure event, the transactional memory system 110 may determine a possible event during the execution of a prior transaction that may have resulted in the failure, such as an interrupt or memory update operation. As depicted in FIG. 6, operation_{—}3 of transaction 2 (604) may represent such a point in the execution of the code at which such an event may occur. In certain other embodiments, an event may also be an inflection point in the code, such as a code fork, branch or a function call, such that rewinding the state of the environment (e.g., instruction pointer, memory state, etc.) to an operation or a plurality of operations prior to the execution of the event may reverse the operation at which the event occurred.

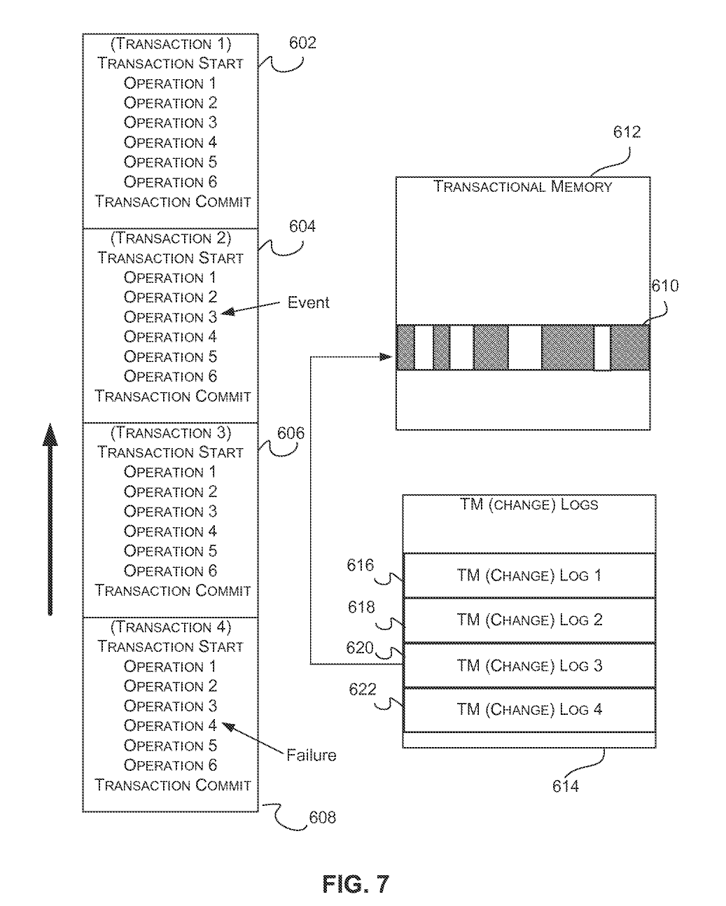

FIG. 7 illustrates reverting or rewinding changes to the portion of transactional memory 610 caused by the execution of operations from transaction 3 (606). After the determination of an event in prior transactions, such as transaction 2 (604), the transactional memory system 110 may revert or rewind all the operations belonging to the transactions up to and including the transaction at which the event leading to the failure was determined to be by the transactional memory system 110. For example, in FIG. 7, after reverting the changes by the ongoing transaction (i.e., transaction 4) during which the failure occurred (622) (as shown in FIG. 6), the transactional memory system 110 uses the TM log 3 (620) to revert the changes to transactional memory 612 caused by the operations of transaction 3 (606). Reverting the changes to the transactional memory 612 results in reverting the changes to the transactional memory 612 caused by the executing of the operations 1-6 of the transaction 3 (606). In other words, reverting the changes to the transactional memory 612 caused by the execution of the operations from transaction 3 (606) using the TM log 3 (620) causes the transactional memory 612 to be in a state prior to the execution of transaction 3 (606) and as if the operations from transaction 3 (606) had never been executed.

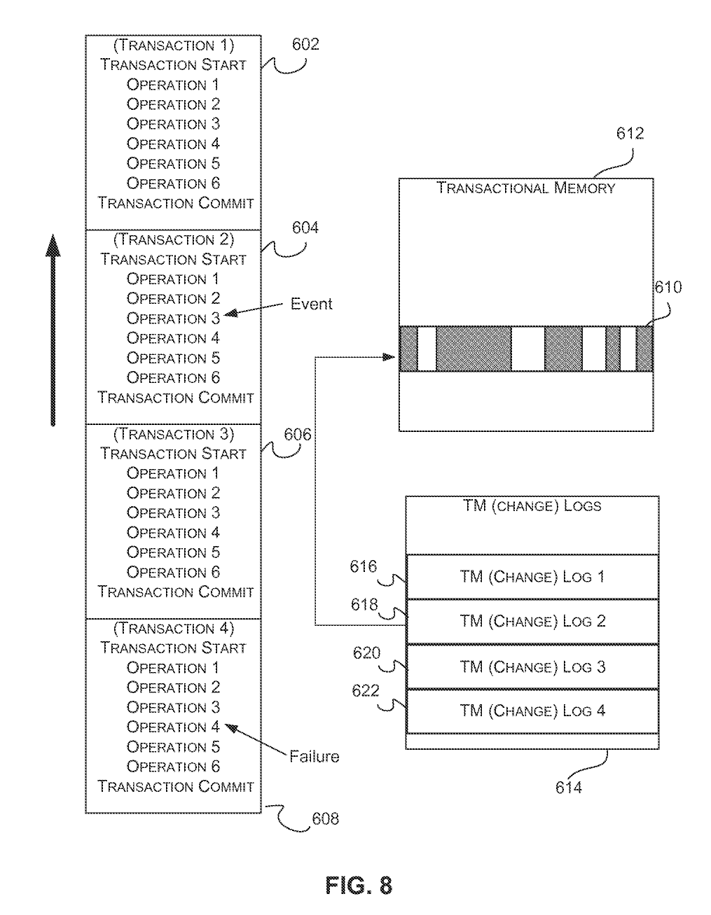

FIG. 8 illustrates reverting or rewinding changes to the portion 610 of transactional memory 612 caused by the execution of operations from transaction 2 (604). The transactional memory system 110 may revert the changes to the transactional memory 612 by the operations of transaction 2 (604), since the event was determined to originate from an operation (i.e., operation_{—}3) from transaction 2 (604). The changes to the portion 610 of transactional memory 612 may be reverted or rewound, using information from the TM log 2 (618) indicating the changes committed to the portion 610 of the transactional memory 612 by completion of the execution of the operations of the transaction 2 (604). In certain embodiments, the changes to the transactional memory 612 caused by the entire transaction are reverted, even though the event that might have caused or was at least temporally associated with the failure is not the first operation of the transaction. In certain embodiments, the information indicating the changes to the memory by the operations of a transaction may be stored in the TM log on a per transaction basis and not for individual operations, necessitating, in some instances, reverting the changes caused by the entire transaction.

Once all the transactional memory 612 has been restored to a state prior to the execution of the transaction (i.e., transaction 2 (604)) during which the event may have occurred that led to the failure, the transactional memory system 110 may take additional steps to alleviate the error condition. For example, the transactional memory system 110 may simply cause the processing entity and the system to re-execute the transactions. In some instances, a boundary condition that resulted in the event may have occurred due to the convergence of a number of asynchronous conditions, such as interrupts, and may not manifest itself in consecutive runs of the same transactions at a different time. To minimize the downtime, the transactional memory system may re-execute the transactions (i.e., transaction 2 (604), transaction 3 (606) and transaction 4 (608)) and log the event, the failure and the execution environment of the failure for later analysis.

In certain embodiments, the transactional memory system 110 may perform an analysis of the failure and take corrective measures before re-executing the transactions. For example, the transactional memory system 110 may cause the processing entity to flush out its internal state and buffers, clear out portions of memory, temporarily disable interrupts, etc., before re-executing transaction 2 (604), transaction 3 (606) and transaction 4 (608)). In certain embodiments, in addition to or in the alternative, the transactional memory system 110 may cause one or more operations during which the event occurred or the transaction, including the operation during which the event occurred, to be either replaced with other operations or transactions or skipped during the re-execution of the transaction. In yet other additional or alternative approaches, the transactional memory system 110 may log the event, failure and aspects of the operating environment and report such information to an external entity for later analysis.

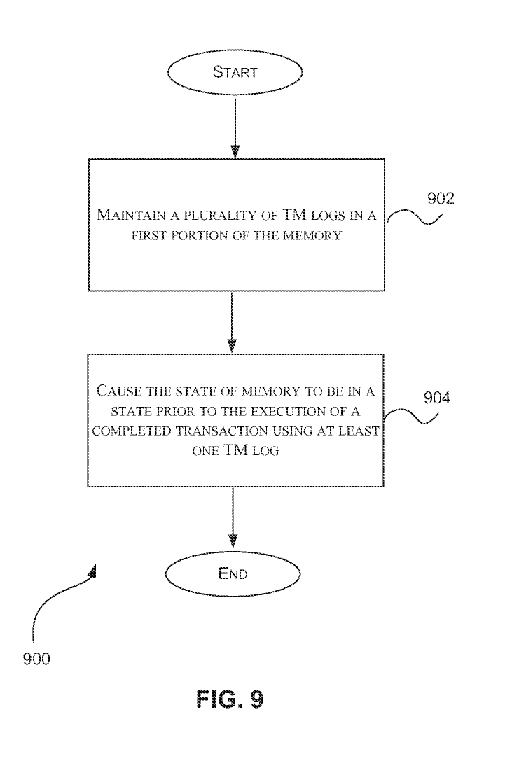

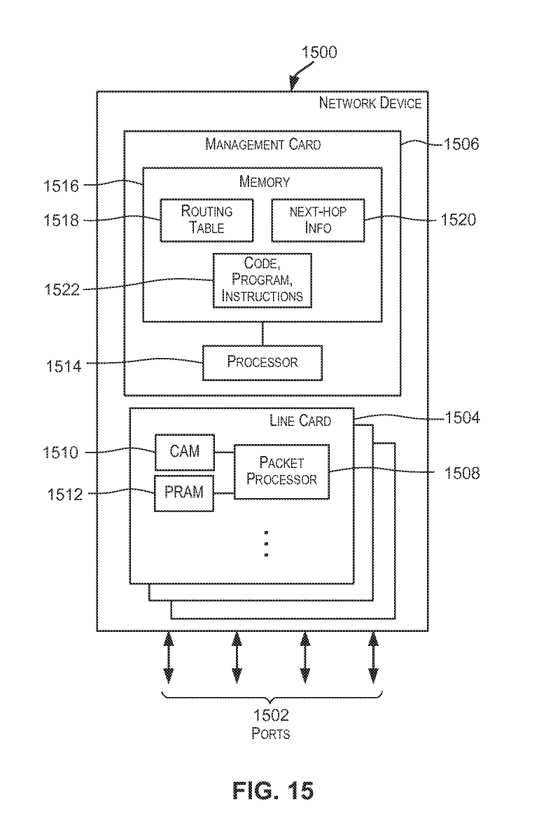

FIG. 9 depicts a simplified flowchart 900 illustrating the method performed according to one or more embodiments of the invention. According to one or more aspects, any and/or all of the methods and/or method steps described herein may be implemented by components of the device 1500 described in FIG. 15. In other implementations, the method may be performed by components of the network device described in FIG. 1-8. In one embodiment, one or more of the method steps described below with respect to FIG. 9 are implemented by one or more processing entities of the network device. Additionally or alternatively, any and/or all of the methods and/or method steps described herein may be implemented in computer-readable instructions, such as computer-readable instructions stored on a computer-readable medium such as the memory, storage or another computer readable medium.

At step 902, components of the device are configured to maintain a plurality of TM logs in a first portion of the memory. Each TM log may be associated with a transaction from a plurality of transactions, wherein each transaction comprises a plurality of operations. Each TM log associated with a transaction may include information associated with changes to a second portion of the memory caused by the execution of all of the operations of the transaction using one or more processing entities.

At step 904, components of the device may be configured to cause the state of a second portion of memory to be in a state prior to the execution of a completed transaction using at least one TM log for a completed transaction from the plurality of TM logs.

It should be appreciated that the specific steps illustrated in FIG. 9 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination therebetween. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process.

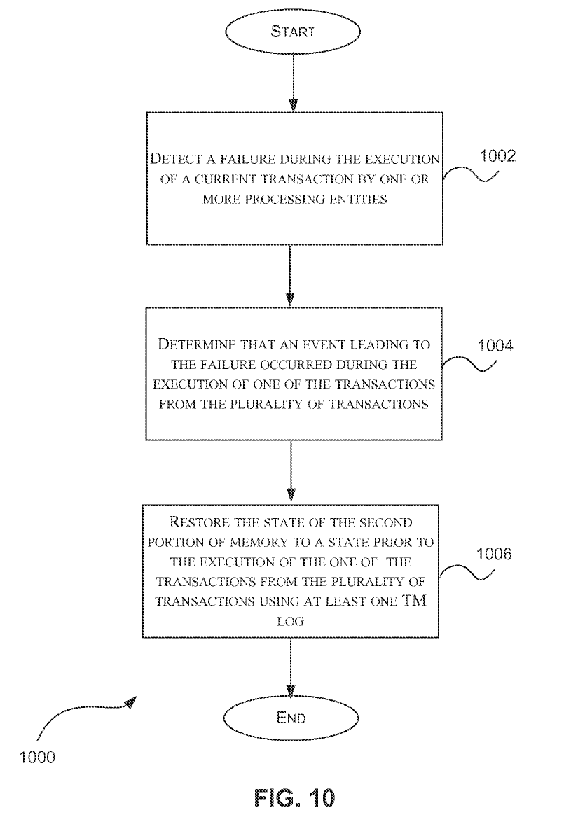

FIG. 10 depicts a simplified flowchart 1000 illustrating the method performed according to one or more embodiments of the invention. According to one or more aspects, any and/or all of the methods and/or method steps described herein may be implemented by components of the device 1500 described in FIG. 15. In other implementations, the method may be performed by components of the network device described in FIG. 1-8. In one embodiment, one or more of the method steps described below with respect to FIG. 10 are implemented by one or more processing entities of the network device. Additionally or alternatively, any and/or all of the methods and/or method steps described herein may be implemented in computer-readable instructions, such as computer-readable instructions stored on a computer-readable medium such as the memory, storage or another computer readable medium.

At step 1002, components of the device may detect a failure during the execution of a current transaction by one or more processing entities, wherein the current transaction is a transaction from a plurality of transactions executing sequentially. In some instances, a failure may be detected by a checking operation operating as part of the transaction. In other instances, the failure event may cause a failure of the process or the processing entity and result in a reboot of the process or the processing entity.

At step 1004, components of the device may determine that an event leading to the failure occurred during the execution of a previously executed transaction from the plurality of transactions. The event leading to the failure may include any inflection point in the code or the behavior in the system that has a high probability of leading up to the failure. For example, the event may include an interrupt, a memory update, an I/O read or write. In certain other embodiments, an event may also be an inflection point in the code, such as a code fork, branch or a function call, such that rewinding the state of the environment (e.g., instruction pointer, memory state, etc.) to an operation or a plurality of operations prior to the execution of the event may reverse the operation at which the event occurred.

In certain embodiments, as described with respect to FIG. 9, the transactional memory system 110 may maintain a plurality of TM logs for currently executing transactions, but also previously executed and completed transactions in memory. In certain embodiments, each TM log may have a one-to-one correspondence to the TM logs and may comprise information indicating the changes to the portion of transactional memory caused by the execution of the operations from the respective TM log. Therefore, the maintained TM logs may comprise a TM log for the currently executing transaction at which the failure event was detected, the previously completed transaction during which the event that may have lead up to the failure might have occurred and any other TM logs for transactions that may have occurred between the two transactions.

At step 1006, components of the device may restore the state of a second portion of memory to a state prior to the execution of the previously executed transaction from the plurality of transactions using one or more TM logs. In certain embodiments, components of the device may use at least the TM log for the currently executing transaction and the TM log for the previously executed transaction for restoring the state of the portion of the transactional memory, using the TM logs. In certain embodiments, components of the device may use the TM log for the currently executing transaction, the TM log for the previously executed transaction during which the event may have occurred, and the TM logs for any other transactions in-between from the plurality of transactions for reverting or rewinding the changes to the portion of memory to a state prior to the execution of the transaction with the suspected event.

It should be appreciated that the specific steps illustrated in FIG. 10 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination therebetween. Moreover, the individual steps illustrated in FIG. 10 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process.

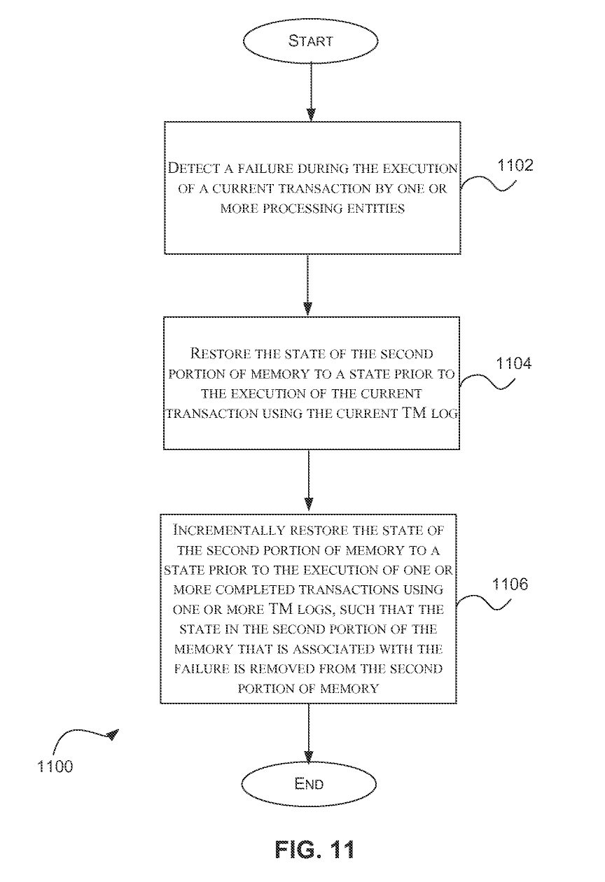

FIG. 11 depicts a simplified flowchart 1100 illustrating the method performed according to one or more embodiments of the invention. According to one or more aspects, any and/or all of the methods and/or method steps described herein may be implemented by components of the device 1500 described in FIG. 15. In other implementations, the method may be performed by components of the network device described in FIGS. 1-8. In one embodiment, one or more of the method steps described below with respect to FIG. 11 are implemented by one or more processing entities of the network device. Additionally or alternatively, any and/or all of the methods and/or method steps described herein may be implemented in computer-readable instructions, such as computer-readable instructions stored on a computer-readable medium such as the memory, the storage or another computer-readable medium.

At step 1102, components of the device may detect a failure during the execution of a current transaction by one or more processing entities, wherein the current transaction is a transaction from a plurality of transactions executing sequentially. In some instances, a failure may be detected by a checking operation operating as part of the transaction. In other instances, the failure may cause a failure of the process or the processing entity and result in a reboot of the process or the processing entity.

In certain embodiments, as described with respect to FIG. 9, the transactional memory system 110 may maintain a plurality of TM logs for currently executing transactions, but also previously executed and completed transactions in memory. In certain embodiments, each TM log may have a one-to-one correspondence to the TM logs and may comprise information indicating the changes to the portion of transactional memory caused by the execution of the operations from the respective TM log.

At step 1104, components of the device may restore the state of a portion of the transactional memory to the state prior to execution of the current transaction using the current TM log.

At step 1106, components of the device may incrementally restore or rewind the state of the portion of transactional memory to a state prior to the execution of one or more completed transactions using one or more TM logs, such that the state of the portion of the transactional memory that is associated with the failure is removed from the transactional memory.

In certain embodiments, components of the device may repetitively rewind the state of the portion of the transactional memory and re-execute the transactions, in each iteration incrementally restoring the state of the memory further back.

In an example scenario, in the first iteration (i=1), components of the device may rewind transactions t (current transaction with the failure) and t−1 (current transaction−1 transaction) and re-execute the t−1 transaction and the t transaction. If the failure does not manifest itself again in transaction t, then the execution of transactions may continue to proceed. However, if the failure is still detected while executing the transaction with the failure (i.e., t), then components of the device may rewind the state further back. For instance, in the second iteration (i=2), components of the device may rewind the portion of the transaction memory such that the changes to the portion of transactional memory caused by the execution of operations from transaction 1, transaction t−1 and transaction t−2 would be reverted and the transactions would be re-executed.

In certain embodiments, components of the device may continue the process of reverting the state of the portion of the transactional memory further back using the TM logs and re-executing the transactions again up to and including the current transaction, either until the failure from the current transactions is no longer manifested upon re-execution of the current transaction or until the transactions cannot be further reverted due to limits on the TM logs stored.

It should be appreciated that the specific steps illustrated in FIG. 11 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination therebetween. Moreover, the individual steps illustrated in FIG. 11 may include multiple sub-steps that may be performed in various sequences as appropriate to the individual step. Furthermore, additional steps may be added or removed, depending on the particular applications. One of ordinary skill in the art would recognize and appreciate many variations, modifications, and alternatives of the process.

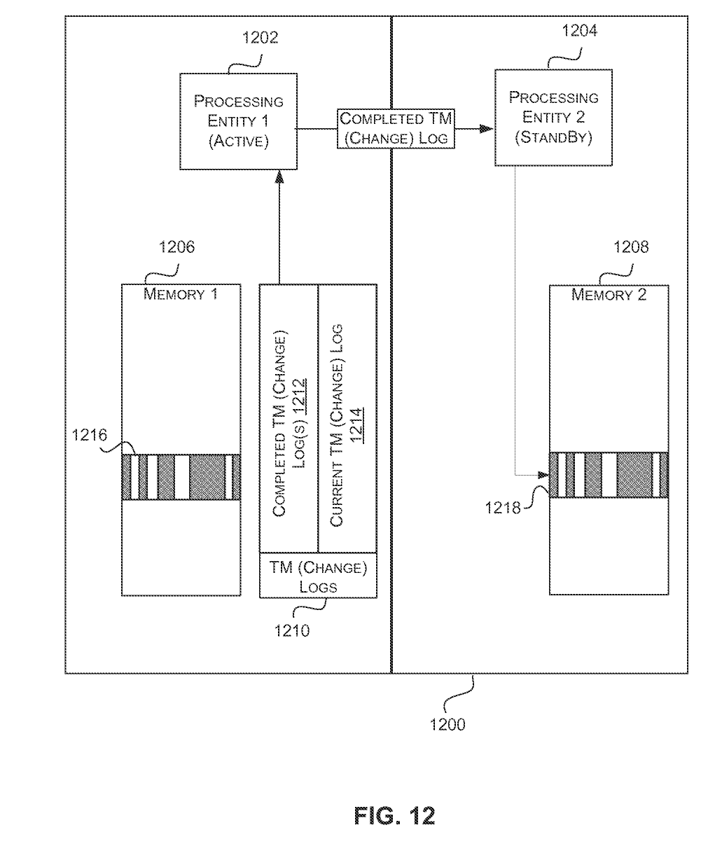

FIG. 12 illustrates a simplified block diagram of a computing device 1500 according to one or more embodiments of the invention. An example of a computing device may include a network device. Examples of network devices include devices such as routers or switches that are configured to route or forward data (e.g., packets) in a network. Examples of such network devices include various devices provided by Brocade Communications Systems, Inc. of San Jose, Calif. The computing device 1200 depicted in FIG. 12, including its various components, is meant for illustrative purposes only and is not intended to limit the scope of the invention in any manner. Alternative embodiments may have more or fewer components than those shown in FIG. 12. Although, not shown, the device and system of FIG. 12 may use components and modules similar to what has been described with respect to FIG. 1 and FIG. 15 to implement certain embodiments of the invention.

As shown in FIG. 12, computing device 1200 comprises multiple processing entities, including a first processing entity 1202 and a second processing entity 1204. Although only two processing entities are shown in FIG. 12, other embodiments of computing device 1200 may comprise more than two processing entities. A processing entity may be a processor, a group of physical processors, a core of a multicore processor, a group of cores of one or more multicore processor, and combinations thereof. In some instances, the first processing entity 1202 and the second processing entity 1204 may be components of two separate computing devices 1200.

For example, in one embodiment, a processing entity of computing device 1200 (e.g., first processing entity 1202 or second processing entity 1204) may be a physical processor, such as an Intel, AMD, or TI processor, or an ASIC. In another embodiment, a processing entity may be a group of processors. In another embodiment, a processing entity may be a processor core of a multicore processor. In yet another embodiment, a processing entity may be a group of cores from one or more processors. A processing entity can be any combination of a processor, a group of processors, a core of a processor, or a group of cores of one or more processors.

In certain embodiments, the processing entity may be a virtual processing unit or a software partitioning unit such as a virtual machine, hypervisor, software process or an application running on a processing unit, such as a physical processing unit, core or logical processor. For example, the two or more processing entities may be virtual machines executing or scheduled for execution on one or more physical processing units, one or more cores executing within the same physical processing unit or different physical processing units, or one or more logical processors executing on one or more cores on the same physical processing unit or separate physical processing units.

In certain embodiments, computing device 1200 may be configured to operate according to the active/standby model for providing high availability. For example, one or more processing entities may operate in a first mode (e.g., active mode) while one or more other processing entities operate in a second mode (e.g., standby mode). For example, as shown in FIG. 12, at a given point in time, first processing entity 1202 may operate in active mode while second processing entity 1204 operates in standby (or passive) mode. The processing entity operating in active mode (i.e., the active processing entity) may be configured to perform a certain set of functions that is not performed by a processing entity operating in standby mode (i.e., the standby processing entity). For example, if computing device 1200 were a network device such as a router or a switch, the set of functions performed in the active mode may include one or more functions related to forwarding and routing of network data. These functions may not be performed by the standby processing entity.

Upon a switchover, caused by a voluntary or an involuntary event, the standby processing entity is configured to start operating in the active mode and become the new active processing entity and take over performance of the functions performed in active mode. The previous active processing entity may operate in the standby mode and become the new standby processing entity. In this manner, the active-standby model uses redundant processing entities to reduce interruptions in data processing and forwarding and thus provides higher availability for the network device.

In certain implementations, each processing entity may have a dedicated portion of memory assigned to or associated with the processing entity. In one embodiment, the memory assigned to a processing entity is random access memory (RAM). Non-volatile memory may also be assigned in other embodiments. For example, in the embodiment depicted in FIG. 12, first processing entity 1202 is coupled to first memory 1206 and second processing entity 1204 is coupled to second memory 1208.

One or more applications may be loaded into memories 1206 and 1208 and executed by processing entities 1202 and 1204 respectively. As previously described, computing device 1200 may be configured to operate according to the active/standby model. For example, first processing entity 1202 may operate in active mode while second processing entity 1204 operates in standby (or passive) mode. When the first processing entity 1202 operates in active mode, one or more applications or processes may be loaded into memory 1206 associated with first processing entity 1202 and executed by first processing entity 1202. These applications and processes, when executed by first processing entity 1202, may perform a certain set of functions that are performed in the active mode (and not performed in the standby mode).

First memory 1206 and second memory 1208 may be physically configured in a variety of ways without departing from the scope of the invention. For example, first memory 1206 and second memory 1208 may reside on one or more memory banks connected to the processing entities using shared or dedicated busses in computing device 1200.

In certain embodiments, the first processing entity 1202 may be configured to execute a process comprising a sequence of transactions, each transaction comprising a plurality of operations. Furthermore, the first memory 1206 or a portion 1216 of the first memory 1206 and the second memory 1208 or a portion 1218 of the second memory 1208 may be implemented as transactional memory and as part of a transactional memory system 110. As previously discussed, the transactional memory system 110 may guarantee consistency of data stored in transactional memory at the atomicity of the transactions. Transactional memory system 110 ensures that changes to transactional memory resulting from execution of the operations in a transaction are committed to transactional memory only upon completion of the transaction.

In certain embodiments, the transactional memory system (TMS) 110 is further provided to maintain TM logs for currently executing transactions and previously completed transactions and facilitate communication of data between first processing entity 1202 and second processing entity 1204 (or, in general, between any two processing entities).

In certain implementations, transactional memory system 110 uses TM logs 1210 to guarantee consistency of data stored in transactional memory on a per transaction basis. In one embodiment, for a sequence of operations in a currently executing transaction, information tracking changes to transactional memory, due to execution of the operations of the currently execution transaction, is stored in the current TM log 1214. The information stored is such that it enables transactional memory system 110 to reverse the memory changes if the current executing transaction cannot be completed. In this manner, the information stored in the TM log 1214 is used by transactional memory system 110 to reverse or unwind any memory changes made due to execution of operations of an incomplete transaction.

In certain embodiments, the transactional memory system 110 may also maintain TM logs for previously completed transactions. In one example, the first processing entity 1202, acting as the active processing entity, may execute applications or processes on the first processing entity 1202, comprising a sequence of transactions. After each successful completion of a transaction or after completion of a plurality of transactions, the first processing entity 1202 may periodically send the one or more completed TM logs 1212 to the second processing entity 1204.

In certain embodiments, the state of a portion 1216 of the first memory 1206 and the state of the portion 1218 of the second memory 1208 are set to be the same at the onset of the application or at the onset of the process from the application executing a plurality of transactions. For example, in some instances, the portion of the first memory 1216 and the portion 1218 of the second memory 1208 are cleared at the start of the application or a process executing as part of the application. Furthermore, in some instances, the portion 1216 of memory of the first memory 1206 may be maintained as part of the transactional memory system 110.

The second processing entity 1204 receives the one or more TM logs 1212 and updates the portion 1218 of second memory 1208 using the received TM logs 1212 from the first processing entity 1202. Each TM log for a completed transaction represents the changes to the portion of memory by the execution of the operations from that transaction. Therefore, each TM log also represents the relative change of the state of memory from before the start of execution of operations from the transaction. The second processing entity 1204 either after each transaction or a plurality of transactions receives one or more TM logs 1212. The TM logs 1212 received by the second processing entity 1204 indicate the relative change in the state of the portion 1216 of the first memory 1206, since the last set of TM logs was received by the second processing entity 1204.

The second processing entity 1204 processes the received TM log and updates the portion 1218 of the second memory 1208, such that the portion of the first memory 1216 and the portion 1218 of the second memory 1208 are synchronized up until the completion of the transactions associated with the received TM logs 1212.

In the event of a switchover, the second processing entity 1204 may become the active processing entity. In the active mode, the second processing entity 1202 may start performing the set of functions that are performed in the active mode. In certain embodiments, instead of restarting the application or the process, the second processing entity 1204 may start executing close to where the first processing entity 1202 left off. For example, since the portion of second memory 1218 maintained by the second processing entity 1204 may be synchronized to a recently completed transaction executed by the first processing entity 1202 (using the received TM logs 1212), the second processing entity 1204 may merely update the instruction pointer for the second processing entity 1204 and start executing from the next operation from the recently completed transaction by the first processing entity 1202.

As described above, the TM logs provide an expedient manner for cataloging all the changes to a portion of memory by a first processing entity 1202 and transferring those changes to a second processing entity 1204. Using the TM logs to transmit the changes reduces the number of transfers between the processing entities, simplifies the architecture for synchronizing the memories maintained by the two processing entities and may also speed up the system. For example, using TM logs for synchronizing the memories may speed up the system by reducing the processing disruptions for the active processing entity for cataloging the changes to the memory, generating messages for sending the changes to a standby processing entity and sending the changes to the second processing entity.

The second processing entity 1204 periodically synchronizes the memory maintained by the second processing entity 1204 to reflect the changes by the first processing entity to its own memory space. In the event of a switchover, the system can almost seamlessly switch the processing of the currently executing application or process to the second processing entity, with minimal downtime.

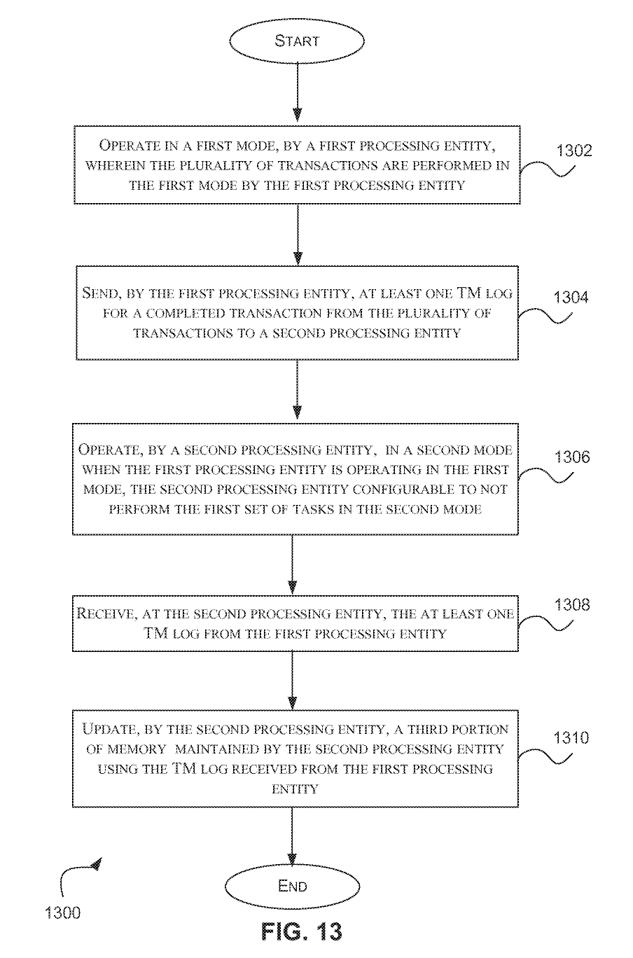

FIG. 13 depicts a simplified flowchart 1300 illustrating the method performed according to one or more embodiments of the invention. According to one or more aspects, any and/or all of the methods and/or method steps described herein may be implemented by components of the device 1500 described in FIG. 15. In other implementations, the method may be performed by components of the network device described in FIGS. 1-8 and FIG. 12. In one embodiment, one or more of the method steps described below with respect to FIG. 13 are implemented by one or more processing entities of the network device. Additionally or alternatively, any and/or all of the methods and/or method steps described herein may be implemented in computer-readable instructions, such as computer-readable instructions stored on a computer-readable medium such as the memory, storage or another computer readable medium.

At step 1302, components of the device, such as a first processing entity, may operate in a first mode, wherein a plurality of transactions are performed in the first mode by the first processing entity. In certain embodiments, the first mode may be an active mode.

At step 1304, the first processing entity may send at least one TM log for a completed transaction from the plurality of transactions to a second processing entity. The TM log may reflect all the changes to a portion of transactional memory caused by the execution of the operations from the completed transaction.

At step 1306, the second processing entity may operate in a second mode, when the first processing entity is operating in a first mode. The second processing entity may be configurable to not perform the first set of tasks in the second mode. In certain embodiments, the second mode may be a standby mode.

At step 1308, the second processing entity may receive the at least one TM log from the first processing entity and process the TM log. At step 1310, the second processing entity may update a third portion of memory maintained by the second processing entity using the TM log received from the first processing entity.

It should be appreciated that the specific steps illustrated in FIG. 13 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination therebetween. Moreover, the individual steps illustrated in FIG. 13 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process.

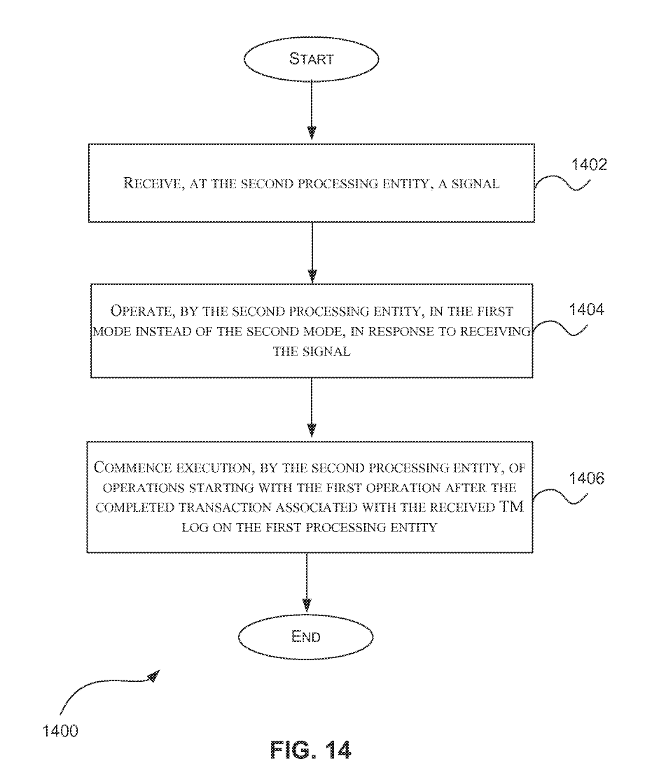

FIG. 14 depicts a simplified flowchart 1400 illustrating the method performed according to one or more embodiments of the invention. According to one or more aspects, any and/or all of the methods and/or method steps described herein may be implemented by components of the device 1500 described in FIG. 15. In other implementations, the method may be performed by components of the network device described in FIGS. 1-8 and FIG. 12. In one embodiment, one or more of the method steps described below with respect to FIG. 14 are implemented by one or more processing entities of the network device. Additionally or alternatively, any and/or all of the methods and/or method steps described herein may be implemented in computer-readable instructions, such as computer-readable instructions stored on a computer-readable medium such as the memory, storage or another computer readable medium.

At step 1402, in a system comprising a first processing entity and a second processing entity, the second processing entity may receive a signal. A signal may be generated due to a switchover event.

A switchover may be caused by various different events, including anticipated or voluntary events and/or unanticipated or involuntary events. A voluntary or anticipated event is typically a voluntary user-initiated event that is intended to cause the active processing entity to voluntarily yield control to the standby processing entity. An instance of such an event is a command received by the network device from a network administrator to perform a switchover. There are various situations when a network administrator may cause a switchover to occur on purpose, such as when software for the active processing entity needs to be upgraded to a newer version. As another example, a switchover may be voluntarily initiated by the system administrator upon noticing performance degradation on the active processing entity or upon noticing that software executed by the active processing entity is malfunctioning. In such scenarios, the network administrator may voluntarily issue a command to the network device that causes a switchover, with the hope that problems associated with the current active processing entity will be remedied when the standby processing entity becomes the new active processing entity. A command to cause a voluntary switchover may also be initiated as part of scheduled maintenance. Various interfaces, including, but not limited to, a command line interface (CLI), may be provided for initiating a voluntary switchover.

An involuntary or unanticipated switchover (also sometimes referred to as a failover) may occur due to some critical failure (e.g., a problem with the software executed by the active processing entity, failure in the operating system loaded by the active processing entity, hardware-related errors on the active processing entity or other router component, and the like) in the active processing entity.

At step 1404, the second processing entity may operate in the first mode (e.g., active mode) instead of the second mode (e.g., standby mode), in response to receiving the signal. In the first mode the second processing entity may start performing the set of functions that are performed in the active mode.

As described in FIGS. 12 and 13, portions of the memory for the first processing entity and the second processing entity may be synchronized periodically up until the last completed transaction using TM logs. Thus, at step 1406, the second processing entity may commence execution of the operations starting with the first operation after the completed transaction associated with the received TM log on the first processing entity.

It should be appreciated that the specific steps illustrated in FIG. 14 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination therebetween. Moreover, the individual steps illustrated in FIG. 14 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process.

FIG. 15 depicts a simplified block diagram of a network device 1500 that may be configured to perform embodiments of the present invention. The network device 1500 illustrates only one management card and line card for illustration purposes, but may be extended to provide multiple management cards and line cards. Network device 1500 may be a router or switch that is configured to forward data such as a router or switch provided by Brocade Communications Systems, Inc. In the embodiment depicted in FIG. 15, network device 1500 comprises a plurality of ports 1502 for receiving and forwarding data packets and multiple cards that are configured to perform processing to facilitate forwarding of the data packets. The multiple cards may include one or more line cards 1504 and one or more management cards 1506. A card, sometimes also referred to as a blade or module, can be inserted into the chassis of network device 1500. This modular design allows for flexible configurations with different combinations of cards in the various slots of the device according to differing network topologies and switching requirements. The components of network device 1500 depicted in FIG. 15 are meant for illustrative purposes only and are not intended to limit the scope of the invention in any manner. Alternative embodiments may have more or fewer components than those shown in FIG. 15.

Ports 1502 represent the I/O plane for network device 1500. Network device 1500 is configured to receive and forward data using ports 1502. A port within ports 1502 may be classified as an input port or an output port depending upon whether network device 800 receives or transmits a data packet using the port. A port over which a data packet is received by network device 1500 is referred to as an input port. A port used for communicating or forwarding a data packet from network device 1500 is referred to as an output port. A particular port may function both as an input port and an output port. A port may be connected by a link or interface to a neighboring network device or network. Ports 1502 may be capable of receiving and/or transmitting different types of data traffic at different speeds including 1 Gigabit/sec, 10 Gigabits/sec, or more. In some embodiments, multiple ports of network device 1500 may be logically grouped into one or more trunks.

Upon receiving a data packet via an input port, network device 1500 is configured to determine an output port for the packet for transmitting the data packet from the network device to another neighboring network device or network. Within network device 1500, the packet is forwarded from the input network device to the determined output port and transmitted from network device 1500 using the output port. In one embodiment, forwarding of packets from an input port to an output port is performed by one or more line cards 1504. Line cards 1504 represent the data forwarding plane of network device 1500. Each line card 1504 may comprise one or more packet processing entities 1508 that are programmed to perform forwarding of data packets from an input port to an output port. A packet processing entity on a line card may also be referred to as a line processing entity. Each packet processing entity 1508 may have associated memories to facilitate the packet forwarding process. In one embodiment, as depicted in FIG. 15, each packet processing entity 1508 may have an associated content addressable memory (CAM) 1510 and a PRAM 1512 for storing forwarding parameters (RAM 1512 may accordingly also be referred to as a parameter RAM or PRAM). In one embodiment, for a packet received via an input port, the packet is provided to a packet processing entity 1508 of a line card 1504 coupled to the input port. The packet processing entity receiving the packet is configured to determine an output port of network device 1500 to which the packet is to be forwarded based upon information extracted from the packet. The extracted information may include, for example, the header of the received packet. In one embodiment, a packet processor 1508 is configured to perform a lookup in its associated CAM 1510, using the extracted information. A matching CAM entry then provides a pointer to a location in the associated PRAM 1512 that stores information identifying how the packet is to be forwarded within network device 1500. Packet processing entity 1508 then facilitates forwarding of the packet from the input port to the determined output port.

Since processing performed by a packet processing entity 1508 needs to be performed at a high packet rate in a deterministic manner, packet processing entity 1508 is generally a dedicated hardware device configured to perform the processing. In one embodiment, packet processing entity 1508 is a programmable logic device such as a field programmable gate array (FPGA). Packet processing entity 1508 may also be an ASIC.

Management card 1506 is configured to perform management and control functions for network device 1500 and thus represents the management plane for network device 1500. In one embodiment, management card 1506 is communicatively coupled to line cards 1504 and includes software and hardware for controlling various operations performed by the line cards. In one embodiment, a single management card 1506 may be used for all the line cards 1504 in network device 1500. In alternative embodiments, more than one management card may be used, with each management card controlling one or more line cards.

A management card 1506 may comprise a processing entity 1514 (also referred to as a management processing entity) that is configured to perform functions performed by management card 1506 and associated memory 1516. As depicted in FIG. 15, the routing table 1518 and associated next-hop and RI information may be stored in memory 1516. The next-hop and RI information may be stored and used in an optimized manner as described above. Memory 1516 is also configured to store various programs/code/instructions 1522 and data constructs that are used for processing performed by processing entity 1514 of management card 1506. For example, programs/code/instructions, which, when executed by processing entity 1514, cause the next-hop information to be stored in an optimized manner, may be stored in memory 1516. In one embodiment, processing entity 1514 is a general purpose microprocessor such as a PowerPC, Intel, AMD, or ARM microprocessor, operating under the control of software 1522 stored in associated memory 1516. In yet other embodiments, virtual machines running on microprocessors may act as one or more execution environments running on the network device.

In one embodiment, the functions performed by management card processing entity 1514 include maintaining a routing table, creating associations between routes in the routing table and next-hop information, updating the routing table and associated next-hop information responsive to changes in the network environment, and other functions. In one embodiment, management processing entity 1514 is configured to program the packet processing entities and associated memories of line cards 1504 based upon the routing table and associated next-hop information. Programming the packet processing entities and their associated memories enables the packet processing entities to perform data packet forwarding in hardware. As part of programming a line card packet processing entity and its associated memories, management processing entity 1514 is configured to download routes and associated next-hops information to the line card and program the packet processing entity and associated memories. Updates to the next-hop information are also downloaded to the line cards to enable the packet processing entities on the line cards to forward packets using the updated information.

What is claimed is:

1. A device comprising:
a memory;
one or more processing entities; and
a transactional memory system configurable to maintain a plurality of transactional memory (TM) logs in a first portion of the memory, wherein:
each TM log is associated with one transaction from a plurality of transactions sequentially executed by the one or more processing entities and each transaction comprises a plurality of operations; and
each TM log associated with each transaction comprises information associated with changes to a second portion of the memory caused by execution of operations from the transaction using the one or more processing entities.

2. The device of claim 1, wherein the transactional memory system is further configurable to:
detect a failure during the execution of a current transaction by the one or more processing entities;
determine that an event leading to the failure occurred during execution of operations from a completed transaction from the plurality of transactions; and
restore state of the second portion of memory to a state prior to the execution of the operations from the completed transaction from the plurality of transactions using an at least one TM log.

3. The device of claim 1, wherein the transactional memory system is further configurable to:
detect a failure during execution of a current transaction by the one or more processing entities;
restore state of the second portion of memory to a state prior to the execution of the current transaction using a current TM log; and
further incrementally restore the state of the second portion of memory to a state prior to the execution of one or more completed transactions using one or more TM logs, such that the state in the second portion of the memory that is associated with the failure is removed from the second portion of memory.

4. The device of claim 1, comprising:
a first processing entity configurable to:
operate in a first mode, wherein the plurality of operations from the plurality of transactions are executed in the first mode by the first processing entity; and
send at least one TM log for a completed transaction from the plurality of transactions to a second processing entity;
the second processing entity configurable to:
operate in a second mode when the first processing entity is operating in the first mode, the second processing entity configurable to not execute the plurality of operations from the plurality of transactions in the second mode;
receive the at least one TM log from the first processing entity; and
update a third portion of memory maintained by the second processing entity using the TM log received from the first processing entity.

5. The device of claim 4, the second processing entity is further configurable to:
receive a signal;
operate in the first mode instead of the second mode, in response to receiving the signal; and
commence execution of operations starting with a first operation after the completed transaction associated with the received TM log from the first processing entity.

6. The device of claim 4, wherein the first processing entity stops executing the transaction in the first mode in response to detecting a signal during execution of a transaction from the plurality of transactions.

7. The device of claim 1, wherein the at least one of the plurality of TM logs for a completed transaction is used for causing the state of the second portion of memory to be in a state prior to the execution of a completed transaction.

8. The device of claim 1, wherein the plurality of TM logs is generated sequentially by the sequential execution of the plurality transactions by the one or more processing entities.

9. The device of claim 1, wherein execution of a memory operation that is a write operation from a transaction from the plurality of transactions changes a second portion of memory and a TM log stored in the first portion of memory.

10. The device of claim 1, wherein each TM log associated with a completed transaction from the plurality of transactions identifies the changes to the second portion of the memory from a state prior to start of first operation of the transaction to completion of last operation of the completed transaction.

11. A method comprising:
maintaining a plurality of transactional memory (TM) logs in a first portion of the memory, wherein:
each TM log is associated with a transaction from a plurality of transactions, wherein each transaction comprises a plurality of operations; and
each TM log associated with the transaction comprises information associated with changes to a second portion of the memory caused by the execution of the operations of the transaction using one or more processing entities.

12. The method of claim 11, further comprising:
detecting a failure during the execution of a current transaction by the one or more processing entities;
determining that an event leading to the failure occurred during execution of operations from a completed transaction from the plurality of transactions; and
restoring state of the second portion of memory to a state prior to the execution of the operations from the completed transaction from the plurality of transactions using an at least one TM log.

13. The method of claim 11, further comprising:
detecting a failure during execution of a current transaction by the one or more processing entities;
restoring state of the second portion of memory to a state prior to the execution of the current transaction, using a current TM log; and
further incrementally restoring state of the second portion of memory to a state prior to the execution of one or more completed transactions, using one or more TM logs, such that the state in the second portion of the memory that is associated with the failure is removed from the second portion of memory.

14. The method of claim 11, comprising:
operating in a first mode, by a first processing entity, wherein the plurality of operations from the plurality of transactions are executed in the first mode by the first processing entity;
sending, by the first processing entity, at least one TM log for a completed transaction from the plurality of transactions to a second processing entity;
operating, by a second processing entity, in a second mode when the first processing entity is operating in the first mode, the second processing entity configurable to not execute the plurality of operations from the plurality of transactions in the second mode;
receiving, at the second processing entity, the at least one TM log from the first processing entity; and updating, by the second processing entity, a third portion of memory maintained by the second processing entity using the TM log received from the first processing entity.

15. The method of claim 14, comprising:
receiving, at the second processing entity, a signal;
operating, by the second processing entity, in the first mode instead of the second mode, in response to receiving the signal; and
commencing execution, by the second processing entity, of operations starting with a first operation after the completed transaction associated with the received TM log from the first processing entity.

16. The method of claim 14, further comprising the first processing entity stopping execution of the transaction in the first mode in response to detecting a signal during execution of a transaction from the plurality of transactions.

17. The method of claim 11, wherein the at least one of the plurality of TM logs for a completed transaction is used for causing the state of the second portion of memory to be in a state prior to the execution of the completed transaction.

18. The method of claim 11, comprising generating the plurality of TM logs sequentially by the sequential execution of the plurality transactions by the one or more processing entities.

19. The method of claim 11, wherein execution of a memory operation that is a write operation from a transaction from the plurality of transactions changes the second portion of memory and a TM log stored in the first portion of memory.

20. The method of claim 11, wherein each TM log associated with a completed transaction from the plurality of transactions identifies the changes to the second portion of the memory from a state prior to start of first operation of the transaction to completion of last operation of the completed transaction.
